(19) United States
(12) Patent Application Publication
(10) Pub. No.: US 2014/0312124 A1
(43) Pub. Date: Oct. 23, 2014

(54) RFID ASSEMBLY INCLUDING SPRING CLIP

(71) Applicant: Cascade Engineering, Inc., Grand Rapids, MI (US)

(72) Inventors: Jerry A. Walker, Grand Rapids, MI (US); R. Michael Lewis, Grand Rapids, MI (US); Bryan L. Schierbeek, Zeeland, MI (US); John E. Misner, Grandville, MI (US); Kevin A. Bull, Cedar Springs, MI (US)

(21) Appl. No.: 14/324,627

(22) Filed: Jul. 7, 2014

Related U.S. Application Data
(62) Division of application No. 13/584,970, filed on Aug. 14, 2012.

(51) Int. Cl. B65F 1/14; G06K 19/077

(52) U.S. Cl. CPC B65F 1/1484; G06K 19/07758
USPC 235/492

(57) ABSTRACT

An RFID assembly for securing an RFID device to a container. The assembly includes a clip having a first leg and a second leg connected by a resiliently flexible byte portion. The RFID device is attached to the clip. The assembly is inserted under and within an upper rim of a container, and the spring force provided by the byte portion secures the clip within the space, hidden from view. The first and/or second legs may include teeth to assist in securing the assembly in position.

### BACKGROUND OF THE INVENTION

The present invention relates to radio frequency identification device (RFID) assemblies, and more particularly to such assemblies for containers such as those used in the waste and recycling fields.

Waste and recycling containers, including wheeled waste carts, are well known and are commonly used. The waste and recyclables that a resident accumulates throughout can be stored in the containers, which can be wheeled to the curb, for example, for collection.

The use of identification tags, devices, or assemblies on containers also is well known. For example, RFID tags can be attached to or embedded within the containers. A collection vehicle can include readers for reading the RFID tags to identify each container.

Several methods have been used for attaching the RFID tags to the containers. One such method is in-molding the RFID tag directly into the container material. However, in-molding is difficult and can result in damage to the RFID tag because of the high temperatures and pressures required for molding.

Another method for attaching the RFID tag is placing the RFID tag in a hard, protective case, and attaching the case to the container using fasteners such as rivets. While this method provides a durable connection of the RFID tag to the container, this method requires the additional steps and costs of drilling holes and installing rivets. Further, powered tools like drills and rivet guns are required to replace or install this type of RFID tag in the field.

Another method that has been used is attaching the RFID tags to the containers with adhesive. Unfortunately, adhesive attachment is not as durable as desired for the rigorous collection environment, and adds to replacement and installation costs in the field because a smooth area must be located, cleaned and dried prior to adhesion of the RFID tag. The ambient temperature must also be within a predetermined range for the adhesive attachment to properly bond.

### SUMMARY OF THE INVENTION

The aforementioned challenges are overcome by the RFID assembly of the present invention. The assembly included an RFID tag and a clip for securing the tag to a container.

In the disclosed embodiment, the clip includes a first leg and a second leg connected by a byte portion. The byte portion provides a spring force urging the legs away from one another. The legs include teeth. The RFID tag is connected to the clip. The clip legs can be flexed to position the clip between two portions of the container. The teeth on the legs bite into the container under the spring force of the clip to secure the assembly in position.

In another aspect of the disclosed embodiment, a method is provided for securing an RFID tag to a container including the steps of (a) providing a clip having first and second legs, (b) securing an identification tag to the clip, and (c) flexing the first and second legs toward one other, and (d) inserting the clip into a space defined by at least two surfaces of the waste container.

The clip is relatively simple and inexpensive, yet it is highly effective. It may be installed in new containers during manufacture/assembly. It also may be used to retrofit carts with identification tags.

These and other advantages and features of the invention will be more fully understood and appreciated by reference to the description of the current embodiment and the drawings.

### BRIEF DESCRIPTION OF THE DRAWINGS

FIG. 1 is a perspective view of a container including the RFID assembly.

FIG. 1A is an enlarged view of the portion of the container including the RFID assembly.

FIG. 2 is a sectional view along the line 2-2 in FIG. 1.

FIG. 3 is a perspective view of the clip.

FIG. 4 is a side view of the clip.

FIG. 5 is a perspective view of the RFID assembly.

FIG. 6 is another perspective view of the RFID assembly.

FIG. 7 is a side view of the RFID assembly.

FIG. 8 is an exploded view of the RFID tag.

### DESCRIPTION OF THE CURRENT EMBODIMENT

Before the embodiments of the invention are explained in detail, it is to be understood that the invention is not limited to the details of operation or to the details of construction and the arrangement of the components set forth in the following description or illustrated in the drawings. The invention may be implemented in various other embodiments and may be practiced or carried out in alternative ways not expressly disclosed herein. Also, it is to be understood that the phraseology and terminology used herein are for the purpose of description and should not be regarded as limiting. The use of “having,” “including,” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

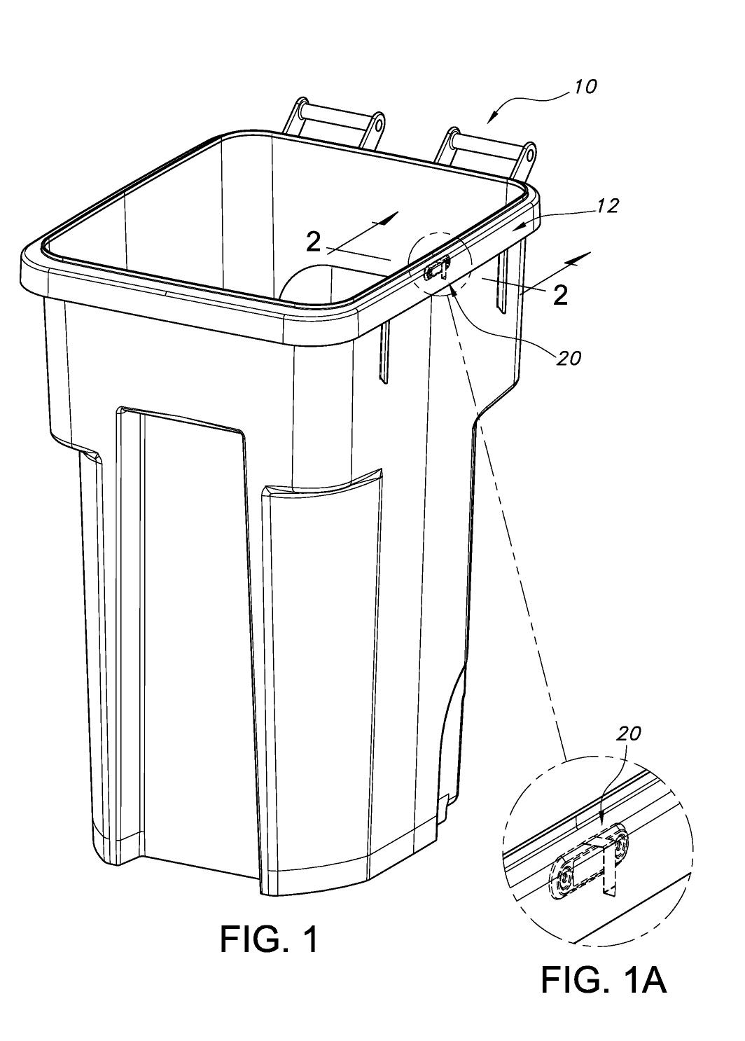

A waste container or cart is shown in FIG. 1 and is generally designated 10. The waste container 10 includes an identification tag assembly 20, including an identification device 22, a case 24, 26, and a clip 30. The identification device 22 may an RFID tag. One side of the case 24 may include a projection 28 received by one leg 34 of the clip 30. The clip 30 may be resiliently flexed and inserted under a rim 12 of the waste container 10. The spring force of the clip 30 may retain the identification tag assembly 20 under the rim 12 out of view of the user. Installation of the clip 30 may be part of the original manufacture of the waste container 10, or may be a simple and easy means for retrofitting or repairing an existing waste container 10. Further, the resilient spring force may allow the clip 30 to secure within a variety of rim sizes.

I. Construction

The container 10 can be formed in any suitable size and shape. In the illustrated embodiment, the container 10 is described in connection with a refuse or recycling container adapted to receive and store waste, yard waste, recyclable materials and/or other waste products. However, the container 10 described in connection with the present invention can be adapted for the receipt and storage of any other type of goods or products, including products to be stored in a container having an RFID tag.

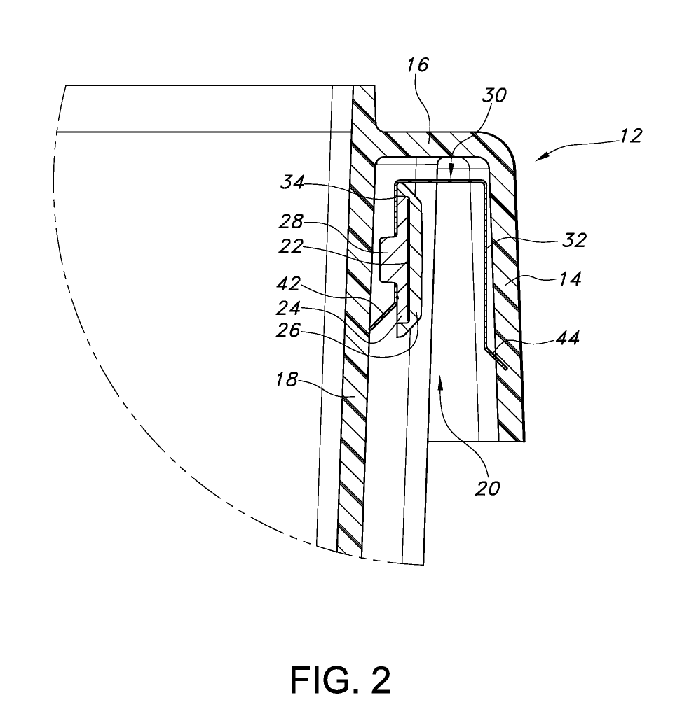

The container 10 includes an overhanging rim 12 positioned adjacent a top edge of the container 10. Although the rim 12 is illustrated as being adjacent the top edge of the container 10, the rim 12 may be positioned anywhere on the container 10 to receive the identification tag assembly 20. Optionally, the identification tag assembly 20 may be received between any two suitable surfaces in the container 10. As shown in FIG. 2, the rim 12 is formed by outer rim surface 14 and lateral rim surface 16. The space below the rim 12 is further bounded by container wall 18.

The identification tag assembly 20 includes an identification tag 22 supported by a case 24, 26 (FIG. 8). In the illustrated embodiment, the tag 22 is enclosed in two halves 24, 26 of the case, but any suitable tag 22 and case configuration may be used. Optionally, the tag 22 may be only partially enclosed by the case. Further optionally, the tag 22 may be adhered or otherwise connected to the case while still being exposed. In this configuration, the tag 22 may be adhered to a backing or other similar support material.

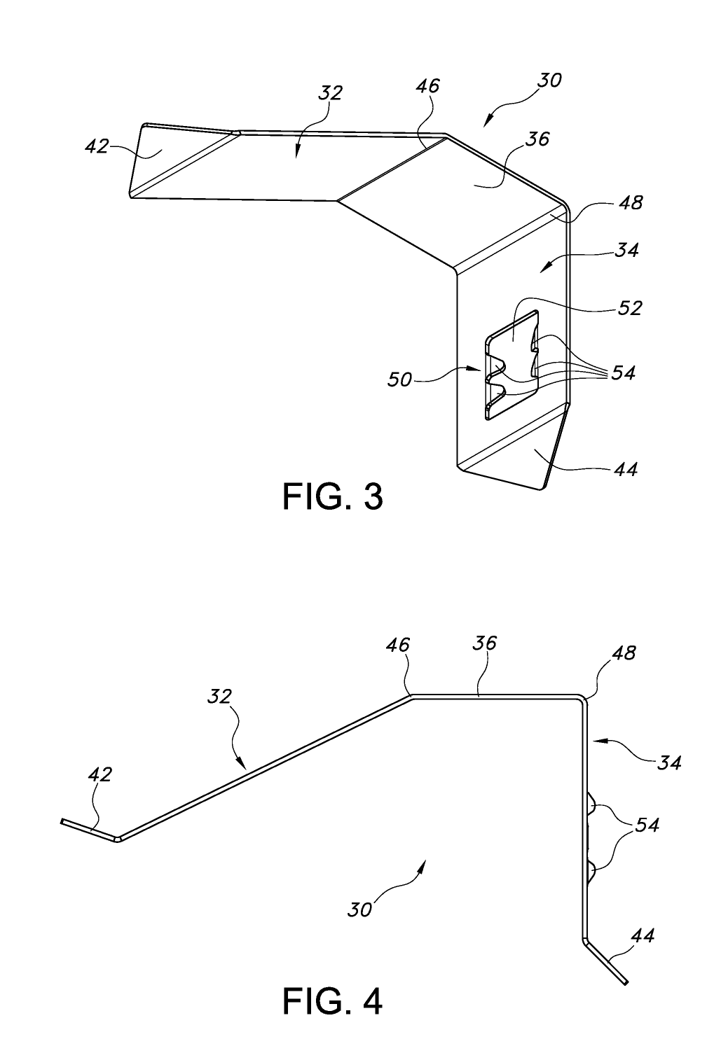

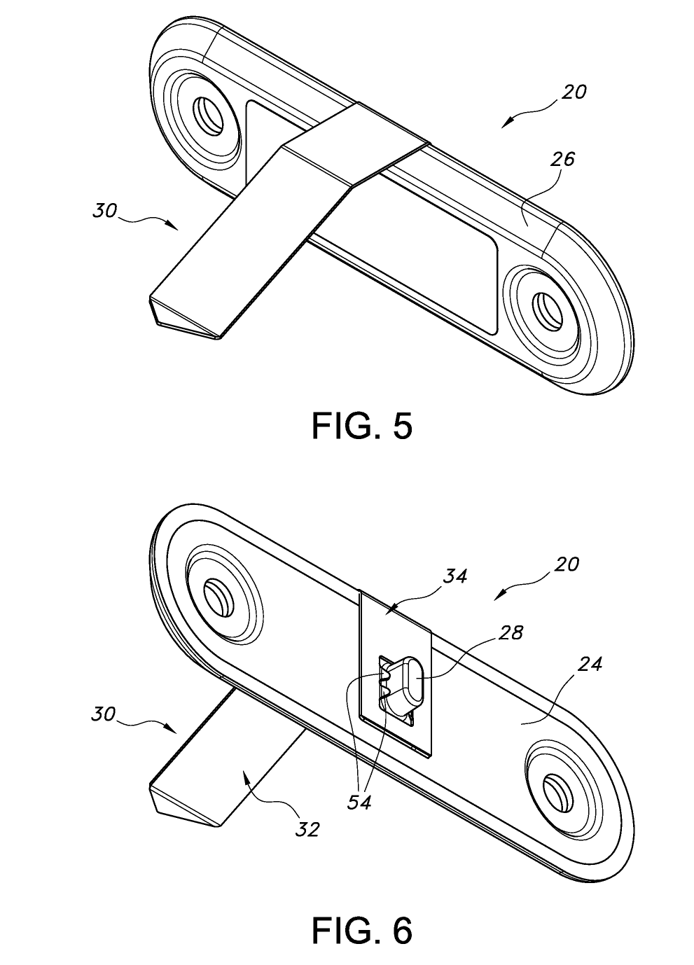

The identification tag assembly 20 includes a clip 30 configured to support the tag 22 and case 24, 26. One portion of the case 24 includes a projection 28 for connecting the case 24, 26 and the clip 30. As shown in FIGS. 3-4, the clip 30 may include a first leg 32, a second leg 34 and a third leg 36. Each leg 32, 34, 36 has an inner surface facing the interior of the clip 30, and an outer surface facing away from the clip 30. The legs 32, 34, 36 may be connected by flexible connections 46, 48 that allow the first leg 32 and second leg 34 to resiliently flex with respect to each other and with respect to the third leg 36. In this configuration, the flexible connections 46, 48 and third leg 36 may be considered a flexible, or byte portion between the first and second legs 32, 34. Optionally, any configuration allowing the desired flexing of the first leg 32 and second leg 34 may be used. For example, the third leg 36 may be eliminated, and the first and second legs 32, 34 may be connected by a flexible byte portion similar to flexible connections 46, 48. Further optionally, the second and third legs 34, 36 may be relatively rigid, and the first leg 32 may flex relative to a remainder of the clip 30. The spring force of the clip 30 may secure the clip 30, identification tag 22 and case 24, 26 to the container 10.

A securing mechanism 50 for securing the identification tag 22 and case 24, 26 to the clip 30 may be included in one of the legs 32, 34, 36. The illustrated securing mechanism 50 includes an aperture 52 defined in the second leg 34 for receiving the case projection 28, and multiple projections 54 extending adjacent the aperture 52 to engage the case projection 28. The securing projections 54 may extend away from the outer surface of the remainder of the second leg 34. This configuration may allow movement of the case projection 28 into the aperture 52 in a direction from the inner surface of the second leg 34 toward the outer surface of the second leg 34, while resisting movement of the case projection 28 through the aperture 52 from the outer surface of the second leg 34 toward the inner surface of the second leg 34. In this manner, the securing mechanism 50 may allow insertion of the identification tag 22 and case 24, 26 into the clip 30, but may resist removal of the identification tag 22 and case 24, 26 from the clip 30. As illustrated, the identification tag 22 may be secured in an area between the first, second and third legs 22, 24, 26.

An attachment mechanism may be included in the clip 30 to further secure the clip 30 to the container 10. In the illustrated embodiment, the attachment mechanism is included in the first and second legs 32, 34 in the form of one or more angled extensions or teeth 42, 44. As illustrated, the extensions 42, 44 may form an angle of less than 180° relative to the outer surfaces of the respective first and second legs 32, 34. The angled configuration may allow the clip 30 to be inserted into the space under the rim 12 of container 10, but may resist undesired removal of the clip 30 by digging into or otherwise frictionally engaging the rim 12 and wall 18 during attempted removal. The attachment mechanism may be any suitable configuration, including substantially triangular-shaped extensions as illustrated. Configurations that include multiple points to dig into the rim 12 and wall 18 are also considered. Optionally, the attachment mechanism may only be included in one of the first and second legs 32, 34.

II. Manufacture and Installation

A clip 30 in accordance with the present invention may be manufactured from any suitable material, including spring steel, other metals, and composites. The clip 30 may be formed with any suitable process, including punching and stamping. The container 10 and case 24, 26 may be formed of any suitable material, including plastic. The container 10 and case 24, 26 may be formed with any suitable process, including injection molding. Optionally, the identification tag 22 may be molded into the case 24, 26.

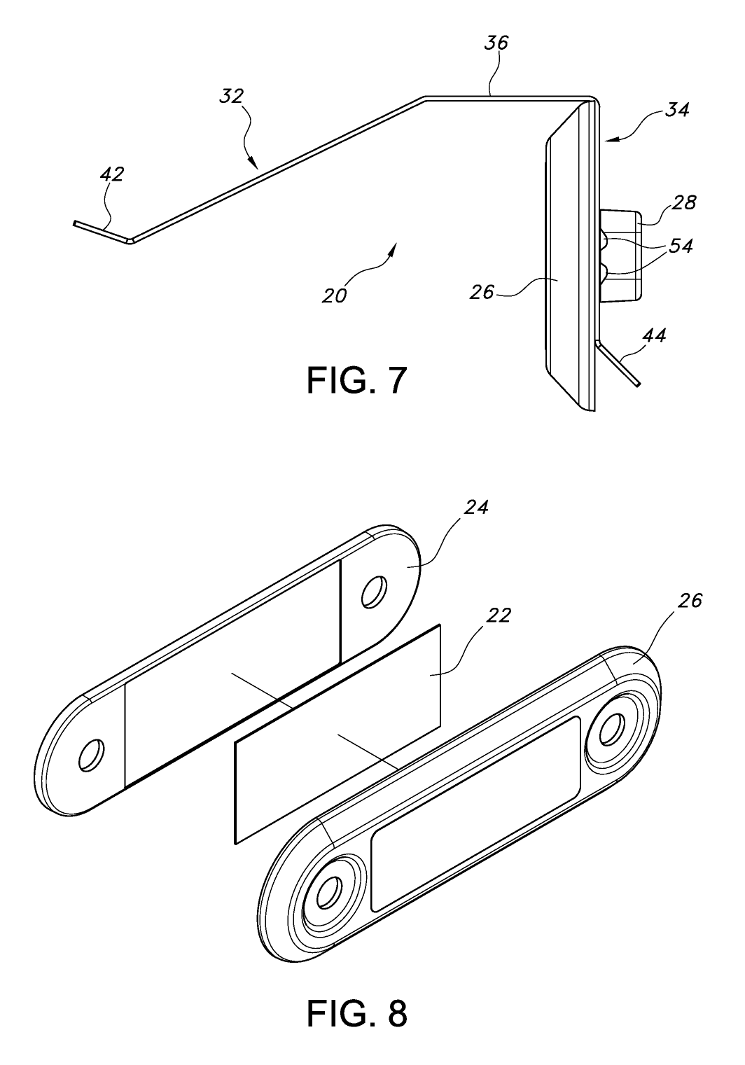

Once the parts are formed, the identification tag 22 may be secured within the case 24, 26 (FIG. 8). The two halves 24, 26 may be secured with any suitable method, including fasteners and adhesives. As noted above, in optional configurations, the identification tag may be supported by and secured to the case while not being positioned within the case. As shown in FIGS. 6-7, the case projection 28 may be inserted into aperture 52 to engage securing projections 54 and connect the identification tag 22 to the clip 30.

The clip 30 may be inserted into the space under the cart rim 12 as illustrated in FIGS. 1-2, or into any other suitable space defined by two surfaces of container 10. During insertion of the clip 30, the first leg 32 may contact the outer rim surface 14 and may flex inward, toward second leg 34. Optionally, the first leg 32 may be manually flexed prior to insertion and released within the space under the cart rim 12 after insertion. Further optionally, both the first and second legs 32, 34 may both be flexed during insertion of the clip 30 within the space under the cart rim 12. The flexed and relaxed positions of first leg 32 can be seen, for example, in FIGS. 2 and 7. In the relaxed position shown in FIG. 7, the inner surfaces of the first and second legs 32, 34 form a first angle. In the flexed position shown in FIG. 2, these surfaces form a second angle that is less than the first angle. Optionally, as shown in FIG. 2, the second angle may be substantially zero, meaning that the first and second legs 32, 34 may be substantially parallel. Further optionally the second angle may be greater than zero, so that the first and second legs 32, 34 are not parallel.

The clip 30 may be inserted into the space under the cart rim 12 as desired until the clip 30 is no longer visible from a vantage point of a typical user, or until the clip 30 contacts the lateral rim surface 16. In the flexed position shown in FIG. 2, first leg 32 and/or the second leg 34 provides a resilient spring force outward against the outer rim surface 14 and the wall 18, which may retain the clip 30 within the space under the cart rim 12. To additionally secure the clip 30, the angled extension 44 on the first leg 32 may dig into or otherwise frictionally engage the outer rim surface 14, as shown in FIG. 2. The extension 44 may be forced into the outer rim surface 14 during installation, or an attempted removal force may dig the angled extension 44 into the outer rim surface 14 to resist undesired removal. As noted above, the angled extension 42 on the second leg 34 may also secure the clip 30 in a similar manner.

To remove clip 30 and identification tag 22 from container 10, the first leg 32 may be flexed inward to disengage the attachment mechanism 44 from the outer rim surface 14, allowing the clip 30 to be removed from the space under the rim 12. The flexing of the first leg 32 may be accomplished by hand or with a tool, depending on the desired force threshold. The second leg 34 may be flexed inward in a similar manner.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. An identification tag assembly for a waste container comprising:
a clip including a first leg and a second leg, the first and second legs being resiliently flexible with respect to one another;
an identification tag supported by the clip; and
an attachment structure on at least one of the first and second legs adapted to securely engage the waste container.

2. The identification tag assembly of claim 1 including a bite portion interconnecting the first leg and the second leg.

3. The identification tag assembly of claim 1 wherein the clip has a relaxed position and a flexed position, the first and second legs forming a first angle in the relaxed position and a second angle in the flexed position, the first angle greater than the second angle.

4. The identification tag assembly of claim 1 wherein the attachment structure is adapted to resist removal of the clip from the waste container.

5. The identification tag assembly of claim 1 wherein the attachment structure (a) is included on the first leg and (b) comprises a substantially triangular-shaped extension.

6. The identification tag assembly of claim 5 wherein the attachment structure (a) is additionally included on the second leg and (b) comprises a substantially triangular-shaped extension.

7. The identification tag assembly of claim 1 wherein the securing structure includes (a) one of the first and second legs defining an aperture and (b) a plurality of projections extending adjacent the aperture.

8. The identification tag assembly of claim 7 wherein the aperture and the projections are adapted to receive a case for the identification tag in a direction from the inner surface of the second leg toward the outer surface of the second leg.

9. The identification tag assembly of claim 1 wherein the first leg and the second leg can be flexed to a substantially parallel position.

10. An identification tag assembly for a waste container comprising:
a clip having a first leg and a second leg, the clip being resiliently flexible, the clip further having at least one projection adapted to engage with a supporting structure; and
an identification tag connected to the clip.

11. The clip assembly of claim 10 including an attachment structure on at least one of the first and second legs and adapted to secure the clip to the waste container.
